(19) United States
(12) Patent Application Publication
(10) Pub. No.: US 2026/0145182 A1
(43) Pub. Date: May 28, 2026

(54) VORTEX TUBE ASSEMBLY

(71) Applicant: Airbus Operations Limited, FILTON (GB)

(72) Inventor: Henry EDWARDS, FILTON (GB)

(21) Appl. No.: 19/388,378

(22) Filed: Nov. 13, 2025

(30) Foreign Application Priority Data
Nov. 28, 2024 (GB) 2417512.7

(51) Int. Cl. B04C 5/22; A62C 3/08; A62C 99/00; B01D 53/24; B04C 5/20

(52) U.S. Cl. CPC B04C 5/22; A62C 3/08; A62C 99/0018; B01D 53/24; B04C 5/20; B01D 2256/10; B01D 2257/104

(57) ABSTRACT

A method of clearing a swirl generator of a vortex tube for an aircraft enclosure inerting system. The vortex tube has an inlet chamber and a vortex chamber which can receive air from the inlet chamber via flow paths in the swirl generator. The method comprises operating the vortex tube in a foreign matter clearance mode in which a reversed flow of gas is passed from the vortex chamber into the inlet chamber through the flow paths and dislodges accumulated foreign matter therefrom. Dislodged foreign matter is then exhausted from the vortex tube then the vortex tube is operated in a normal mode of operation.

### CROSS-REFERENCES TO RELATED APPLICATIONS

This application claims the benefit of United Kingdom Patent Application Number 2417512.7 filed on Nov. 28, 2024, the entire disclosures of which are incorporated herein by way of reference.

### FIELD OF THE INVENTION

The present disclosure relates to the field of vortex tubes for aircraft enclosure inerting systems. It relates particularly, but not exclusively, to vortex tubes for inerting systems which can be used to fill the ullage of an aircraft fuel tank with nitrogen enriched air as a fire safety precaution.

### BACKGROUND OF THE INVENTION

Owing to airworthiness requirements, most commercial aircraft require the use of fuel tank inerting systems among a suite of other measures to prevent aircraft fuel tank fires or explosions. The primary purpose of such inerting systems (also referred to as inert gas generation systems) is to reduce the oxygen (O₂) concentration within the aircraft fuel tank ullage, and hence the ullage flammability, thereby preventing the ability of the ullage to combust. State of the art systems comprise the use of one or more Air Separation Modules (ASMs) to separate bleed air into nitrogen enriched air (NEA), sometimes called oxygen depleted air, and oxygen enriched air (OEA). The OEA is exhausted overboard from the aircraft whilst the NEA is fed in a controlled manner at predetermined rates into the ullage above the fuel in the aircraft's fuel tank or tanks such that the O₂ concentration of the ullage is kept below an upper limit (for instance 12%) during most operating conditions of the aircraft.

In conventional systems bleed air, which is high temperature and pressure air bled from an engine or from a separate compressor fed by a ram air channel, is filtered and cooled before being inputted into the ASM(s). Cooling and filtering of the bleed air is important because the ASM contains a membrane, often in the form of a set of hollow fibers, over which the input air passes. The membrane can be clogged if the input air contains contaminants like dust, and degrades too rapidly if subjected to input air above a certain temperature. The membrane of the/each ASM is permeable to oxygen but not to nitrogen, so as the air passes over the membrane much of the oxygen it contains passes through the membrane while the nitrogen continues along it. This separates the air into the NEA and OEA. The NEA can then be regulated into the ullage, while the OEA can be discarded as mentioned.

An alternative way of producing NEA is through use of a vortex tube. A vortex tube has a vortex chamber into which air is formed into vortex. As the air rotates inside the chamber it produces a hotter stream around the outside and a colder stream towards the middle. Vortex tubes are generally used to provide heating or cooling rather than air separation. However, oxygen, being denser than nitrogen, tends to be thrown out into the outer stream, leaving the inner stream in a nitrogen enriched state.

One problem with vortex tubes is the potential for build-up of foreign matter in the flow path(s) that lead into the vortex chamber. Firstly, dirt such as oil, dust or smoke entrained in the airflow can adhere to the flow path(s) into the vortex chamber and build up over time. Secondly, rust or other corrosion may form and build up in the flow path(s), or form upstream before being carried into the flow path(s) by the air flow. Thirdly, the air is normally accelerated into the vortex chamber through the flow path(s), which expands the air and thus causes a drop in temperature. If the temperature drops below freezing, moisture in the air can freeze upon contact with the flow path(s) and gradually build up there. By one or more such processes the flow path(s) can become partially clogged, affecting the air flow into the vortex chamber and thus negatively impacting performance, or can even become completely blocked such that the vortex tube cannot operate at all. A related problem is that the buildup of foreign matter (such as dirt, corrosion and/or ice) can exacerbate the formation of corrosion in the flow path(s) or elsewhere.

To combat the possibility of clogging, vortex tubes in many applications use filtration and/or air drying apparatus upstream of them, to prevent any dirt or moisture from reaching them. Such apparatus can be quite costly, however, and particularly in the context of aircraft inerting systems the added weight and bulk of such apparatus is particularly detrimental.

Instead or as well, in some applications vortex tubes are subject to frequent inspection and maintenance, for instance disassembling them for cleaning and/or replacing corroded parts. However, this increases the maintenance requirements of the apparatus which uses the vortex tube. In applications such as aircraft enclosure inerting systems, the extra down-time caused by such maintenance requirements may be very costly.

The present invention seeks to mitigate one or more of the above-mentioned problems. Alternatively or additionally, the present invention seeks to provide an improved or alternative method of clearing an inlet manifold of a vortex tube for an aircraft enclosure inerting system, vortex tube, aircraft enclosure inerting system or aircraft.

### SUMMARY OF THE INVENTION

According to a first aspect of the present invention, there is provided a method of clearing a swirl generator of a vortex tube for an aircraft enclosure inerting system, the vortex tube comprising:
an inlet chamber;
a vortex chamber which can receive air from the inlet chamber through at least one flow path in the swirl generator; and
a nitrogen enriched air (NEA) outlet and an oxygen enriched air (OEA) outlet,
   wherein the method comprises:
operating the vortex tube in a normal mode by supplying the inlet air flow to the vortex chamber via the inlet chamber through the at least one flow path, centrifugally separating the inlet air flow into an NEA flow and an OEA flow in the vortex chamber, exhausting NEA from the vortex chamber through the NEA outlet and exhausting OEA through the OEA outlet; then
operating the vortex tube in a foreign matter clearance mode by providing a reversed flow of gas which passes from the vortex chamber to the inlet chamber through the at least one flow path and dislodges accumulated foreign matter from the at least one flow path; and
exhausting dislodged foreign matter from the vortex tube; then
operating the vortex tube in the normal mode again.

Clearing accumulated foreign matter by providing a reversed flow of gas may allow the long-term operation of the vortex tube to be less dependent on air drying and filtration systems, allowing such systems to be smaller, cheaper, lighter or the like. Indeed, it may allow operation of the vortex tube without any such system. Furthermore, clearing accumulated foreign matter using a reversed flow of air may avoid the need for the vortex tube to be disassembled for maintenance (or may mean it must be disassembled less frequently), allowing for longer service intervals. Still further, it may reduce the amount of time moisture or ice spends in contact with the at least one flow path, which may reduce the opportunity for the at least one flow path to corrode.

For the avoidance of doubt, while the above advantages apply to vortex tubes in the context of inerting systems where the purpose is producing NEA, they also apply to vortex tubes used for heating and/or cooling in other contexts.

The dislodged foreign matter may be exhausted simultaneously with the provision of the reversed flow of gas and/or subsequently thereto.

The method may comprise operating the vortex tube in the foreign matter clearance mode and exhausting dislodged foreign matter after operation of the vortex tube in the normal mode is first initiated (for instance when an aircraft enclosure inerting system comprising the vortex tube is activated, e.g., after engine start of an aircraft comprising the enclosure inerting system.

This may be beneficial in that start-up is often the time at which a vortex tube is most prone to the accumulation of foreign matter, for instance due to foreign material that has accumulated while the vortex tube has been inactive. In the case of an aircraft enclosure inerting system, the vortex tube may be most prone to the accumulation of foreign matter due to there being more dirt in the atmosphere at ground level than at altitude, therefore operating the vortex tube in the foreign matter clearance mode upon engine start-up may be of particular benefit to performance.

The reversed flow of gas may be provided by applying gas pressure to at least one of the outlets.

This may be a particularly convenient way in which the reversed flow of gas can be provided, and/or may allow the reversed flow of gas to be particularly powerful (which, in turn, may improve its ability to dislodge foreign matter).

Alternatively or in addition, the reversed flow of gas may be provided by applying suction to the inlet chamber. If suction is applied to the inlet chamber instead of gas pressure being applied to at least one of the outlets, at least one of the outlets may be connected to ambient pressure so as to allow the suction to draw in ambient air.

Gas pressure may be applied to the at least one of the outlets by diverting the inlet air flow to the at least one of the outlets.

This may reduce or eliminate the need for an additional source of gas pressure, and a suitable control system, to be provided.

As an alternative, the gas pressure may be applied by activating a pump or connecting a compressed gas tank to the at least one of the outlets.

The reversed flow of gas may be provided by applying the gas pressure to one of the outlets and preventing gas flow through the other of the outlets.

This may make the reversed flow of gas stronger and thus more able to dislodge foreign matter. In comparison, in an arrangement where the other of the outlets was left open, some of the gas pressure may be lost due to air flow through that outlet and the reversed flow of gas may therefore be weaker.

That being said, in some embodiments a sufficiently strong reversed flow of gas may be provided with the other of the outlets left open. Leaving the other of the outlets open may allow the vortex tube to be switched between the normal mode and the foreign matter clearance mode more quickly. Instead or as well, leaving the other of the outlets open may avoid the need to provide a valve of the like at that outlet in order to prevent gas flow through it.

The gas pressure may applied to at least the NEA outlet.

This may reduce the risk of dislodged foreign matter reaching the NEA outlet (whereupon it may become entrained in a flow of NEA and cause problems in downstream equipment).

The exhaustion of dislodged foreign matter may take place while the reversed flow of gas is being provided.

This may mean that less time must be spent with the vortex tube not being operated in the normal mode, which in turn may improve the purity and/or flow rate of NEA produced in a given time frame. Instead or as well, exhausting the foreign matter while the reversed flow of gas is being provided may allow the foreign matter to be dislodged and exhausted in a single continuous flow of gas, rather than being dislodged and then exhausted separately.

The dislodged foreign matter may be exhausted through a waste valve, the waste valve being open when the vortex tube is in the foreign matter clearance mode and closed whenever the vortex tube is in the normal mode.

This may reduce the risk of dislodged foreign matter collecting elsewhere in the vortex tube, or in equipment comprising the vortex tube, after having been dislodged.

As an alternative, the dislodged foreign matter may be exhausted through the OEA outlet, for example.

The dislodged foreign matter may be exhausted after the reversed flow of gas has been provided.

This may allow the vortex tube to be operated differently while dislodging the foreign matter and while exhausting the foreign matter, allowing the air flow through the vortex tube to be tailored to each specific function.

The dislodged foreign matter may be exhausted through the OEA outlet.

This may reduce the risk of dislodged foreign matter collecting at the inlet and/or at the NEA outlet, whereupon it may be more likely to come loose while the vortex tube is being operated in the normal mode (at which point it could pollute the NEA stream and cause problems downstream).

The dislodged foreign matter may be exhausted through the OEA outlet by placing the vortex tube in a foreign matter flushing mode in which gas pressure is applied to the NEA outlet.

This may further minimize the chances of dislodged foreign matter collecting at the inlet and/or the NEA outlet.

In the foreign matter flushing mode gas flow through the inlet chamber may be prevented, or gas pressure may also be applied to the inlet chamber. Where gas pressure is also applied to the inlet chamber, this may take the form of maintaining the inlet air flow to the inlet chamber during the foreign matter clearance mode.

The method may further comprise widening the OEA outlet before or during exhaustion of the dislodged foreign matter therethrough, then re-narrowing it before or during the subsequent operation of the vortex tube in the normal mode.

This may reduce the risk of dislodged foreign matter collecting at the OEA outlet rather than being exhausted, for instance allowing for a faster gas flow through the OEA outlet and/or allowing larger clumps of foreign matter to pass through the OEA outlet, with less or no impact on the separation performance of the vortex tube when operating in the normal mode.

Instead or as well, the method may comprise narrowing and then widening the OEA during exhaustion of the dislodged foreign matter.

The narrowing may compress and/or break up foreign matter that has collected in the OEA outlet, making it easier for the foreign matter to then pass through OEA outlet when it is widened.

The method may comprise repeatedly narrowing and widening the OEA outlet during provision of the reversed flow of gas.

This may further improve the clearing of foreign matter that has collected in the OEA outlet

The vortex tube may be operated in the foreign matter clearance mode upon detection of a possible obstruction of the at least one flow path.

The possible obstruction may be a possible constriction of the at least one flow path, and/or a possible complete blockage of the at least one flow path.

Entering the foreign matter clearance mode upon detection of a possible obstruction may avoid unnecessarily entering the foreign matter clearance mode, thereby allowing the vortex tube to spend more time in the normal mode (meaning that the overall output of NEA over long periods may be higher).

The possible obstruction may be detected by monitoring the throughput and/or oxygen content of NEA, for instance using a flow rate sensor and/or an oxygen concentration sensor. For example, a reduction in flow rate and/or an increase in oxygen content of NEA may indicate a possible obstruction. As another example, the possible obstruction may be detected by monitoring the temperature of the NEA and/or the OEA. The amount of separation of air not only determines the purity of the NEA but also determines the temperature change experienced by the NEA and OEA, therefore temperature change can be used as an analogue for oxygen concentration (or vice versa).

The vortex tube may be operated in the foreign matter clearance mode after the vortex tube has been operated in the normal mode for a predetermined period of time.

Operating the vortex tube in the foreign matter clearance mode after a particular time may serve as preventative maintenance, reducing the risk of foreign matter building up to a level at which it may affect the performance of the vortex tube (or affect it to too great an extent).

In some embodiments the vortex tube is operated in the foreign matter clearance mode every time the vortex tube has been operated in the normal mode for a predetermined period, and also operated in the foreign matter clearance mode whenever a possible obstruction of the at least one flow path is detected.

The method may further comprise widening the at least one flow path before or during provision of the reversed flow of gas, then re-narrowing it before or during the subsequent operation of the vortex tube in the normal mode.

This may allow the reversed flow of gas to pass through the at least one flow path at an advantageously high flow rate, which may improve the foreign matter clearing action, without negatively affecting separation performance when the vortex tube is in the normal mode (since too wide a flow path may reduce vortex speed). Indeed, in some embodiments widening the at least one flow path may allow some foreign matter to clear (and be exhausted along with the OEA) while the vortex tube is being operated in the normal mode.

Instead or as well, the method may comprise narrowing and then widening the at least one flow path before or during provision of the reversed flow of gas.

The narrowing may compress and/or break up accumulated foreign matter, making it easier for it to then pass through the at least one flow path when it is widened.

The method may comprise repeatedly narrowing and widening the at least one flow path before or during provision of the reversed flow of gas.

This may further improve the clearing of accumulated foreign matter from the at least one flow path.

The method may comprise narrowing the at least one flow path from a first width to a second width, then widening the at least one flow path to a third width which is wider the first width, then returning the at least one flow path to the first width, before or during provision of the reversed flow of gas.

For instance, the method may comprise:
during provision of the reversed flow of gas, narrowing the at least one flow path from a first width to the second width, then widening the at least one flow path to the third width, then returning the at least one flow path to the first width; then
detecting whether or not accumulated foreign matter has been dislodged from the at least one flow path (for instance using an oxygen concentration sensor and/or a flow rate sensor); then if foreign matter has not been dislodged
during continued provision of the reversed flow of gas, narrowing the at least one flow path from a first width to the second width, then widening the at least one flow path to the third width, then returning the at least one flow path to the first width.

Optionally:
the or each flow path is co-operatively formed by an inner surface of an inlet passage extending through the swirl generator and an outer surface of a throttle pin received in the inlet passage; and
the or each flow path is widened and narrowed by moving the or each throttle pin relative to the corresponding inlet passage.

The at least one flow path being provided in this way may give it an annular cross section, which may be less vulnerable to being completely clogged. Instead or as well, movement of the throttle pin may help to dislodge foreign matter from that flow path.

The method may further comprise applying heat to the swirl generator.

This may melt any ice that has built up in the at least one flow path, and/or soften or melt other types of foreign matter, making it easier to remove.

Heat may be applied to the swirl generator during operation of the vortex tube in the normal mode.

This may loosen the ice in advance of the reversed flow of gas being applied, which may allow the vortex tube to be operated in the foreign matter clearance mode for a shorter time (which in turn may allow it to be operated in the normal mode for a larger proportion of the time, improving the amount of NEA which can be produced in a given time).

For example, the heat may be applied immediately before the vortex tube is operated in the foreign matter clearance mode.

Heat may be applied to the swirl generator substantially throughout operation of the vortex tube in the normal mode.

This may act to prevent ice accumulating to some extent, rather than merely allowing it to accumulate and then clearing it. This may reduce the frequency with which foreign matter must be cleared, and/or reduce the time the time over which the formation of ice can contribute to corrosion.

Heat may be applied during operation of the vortex tube in the foreign matter clearance mode.

This may avoid the risk of ice forming while the vortex tube is being operated in the foreign matter clearance mode, and/or may improve the ability of the reversed flow of gas to dislodge accumulated foreign matter.

In some embodiments heat may be applied substantially only during operation of the vortex tube in the foreign matter clearance mode. This may improve the energy efficiency with which the vortex tube can be operated.

The dislodged foreign matter may be exhausted through a filter or into a waste sump.

This may reduce the risk of dislodged foreign matter accumulating elsewhere in the vortex tube or apparatus comprising the vortex tube. Instead or as well, it may allow the vortex tube to release fewer airborne contaminants during use, or may even allow it to perform an air cleaning function.

According to a second aspect of the present invention there is provided a vortex tube assembly comprising a vortex tube and one or more valves operably connected to a controller, the vortex tube comprising:
an inlet chamber configured to receive an inlet air flow;
a vortex chamber configured for centrifugal separation of the inlet air flow into a nitrogen enriched air (NEA) flow and an oxygen enriched air (OEA) flow;
a swirl generator having at least one flow path configured to allow the inlet air flow to enter the vortex chamber from the inlet chamber; and
an NEA outlet and an OEA outlet,
wherein the controller is configured to operate the one or more valves to move the vortex tube between:
a normal mode in which the inlet air flow passes from the inlet chamber through the at least one flow path into the vortex chamber and is centrifugally separated into the NEA flow and the OEA flow; and
a foreign matter clearance mode in which a reversed flow of gas is passed from the vortex chamber to the inlet chamber through the at least one flow path in the swirl generator so as to dislodge accumulated foreign matter from the at least one flow path.

Being able to enter such a foreign matter clearance mode may make the vortex tube to be less dependent on air drying and filtration systems, allowing such systems to be smaller, cheaper, lighter or the like. Indeed, it may eliminate the need for such systems. Furthermore, being able to clear accumulated foreign matter using a reversed flow of air may avoid the need for the vortex tube to be disassembled for maintenance (or may mean it must be disassembled less frequently), allowing for longer service intervals. Still further, it may reduce the amount of time moisture or ice spends in contact with the at least one flow path, which may reduce the opportunity for the at least one flow path to corrode.

According to a third aspect of the present invention there is provided a vortex tube for a method according to the first aspect of the invention.

Such a vortex tube may allow the provision of one or more of the advantages discussed above.

In any aspect of the invention, for example, the swirl generator may be positioned concentrically between the inlet chamber and the vortex chamber

Such a swirl generator may be particularly vulnerable to clogging, therefore one or more of the advantages discussed above may be of particular benefit.

As one alternative, the inlet chamber and vortex chamber may be axially spaced from one another with the swirl generator being positioned therebetween. In such an arrangement the, or each, inlet path of the swirl generator may follow a generally helical path.

According to a fourth aspect of the invention there is provided an aircraft enclosure inerting system comprising a vortex tube according to the second or third aspect of the invention.

For the reasons discussed above, such an aircraft enclosure inerting system may utilize smaller, lighter and/or cheaper air drying and filtration systems, or may not need any such systems. Instead or as well, it may require less frequent disassembly for maintenance and/or may be subject to less corrosion.

According to a fifth aspect of the present invention there is provided an aircraft comprising an enclosure inerting system according to the fourth aspect of the invention.

For the reasons discussed above, such an aircraft may utilize smaller, lighter and/or cheaper air drying and filtration systems, or may not need any such systems. Instead or as well, its maintenance interval may be longer and/or the total time or man-hours required for maintenance may be reduced.

It will of course be appreciated that features described in relation to one aspect of the present invention may be incorporated into other aspects of the present invention.

### BRIEF DESCRIPTION OF THE DRAWINGS

Embodiments of the present invention will now be described by way of example only with reference to the accompanying schematic drawings of which:

FIG. 1 shows a plan view of an aircraft according to a first embodiment of the invention;

FIG. 2 shows a simplified cross-sectional side view of a vortex tube of an enclosure inerting system of the aircraft of FIG. 1;

FIG. 3 shows a simplified cross-sectional end view of the vortex tube of FIG. 2;

FIG. 4 shows a vortex tube assembly comprising the vortex tube of FIGS. 2 and 3, with the vortex tube being operated in a normal mode;

FIG. 5 shows a simplified cross-sectional end view of the vortex tube of FIGS. 2 and 3, clogged with accumulated foreign matter;

FIG. 6 shows a simplified cross-sectional end view of the vortex tube of FIGS. 2 and 3, with a reversed flow of gas clearing accumulated foreign matter therefrom;

FIG. 7 shows the vortex tube assembly of FIG. 4, with the vortex tube being operated in a foreign matter clearance mode;

FIG. 8 shows a flow chart of a method according to the first embodiment of the invention;

FIG. 9 shows a vortex tube assembly according to a second embodiment of the invention, with a vortex tube thereof being operated in a normal mode;

FIG. 10 shows the vortex tube assembly of FIG. 9, with the vortex tube being operated in a foreign matter clearance mode;

FIG. 11 shows the vortex tube assembly of FIGS. 9 and 10, with the vortex tube being operated in a foreign matter flushing mode;

FIG. 12 shows a flow chart of a method according to the second embodiment of the invention; and

FIG. 13 shows a simplified cross-sectional end view of a vortex tube of a third embodiment of the invention;

### DETAILED DESCRIPTION OF THE PREFERRED EMBODIMENTS

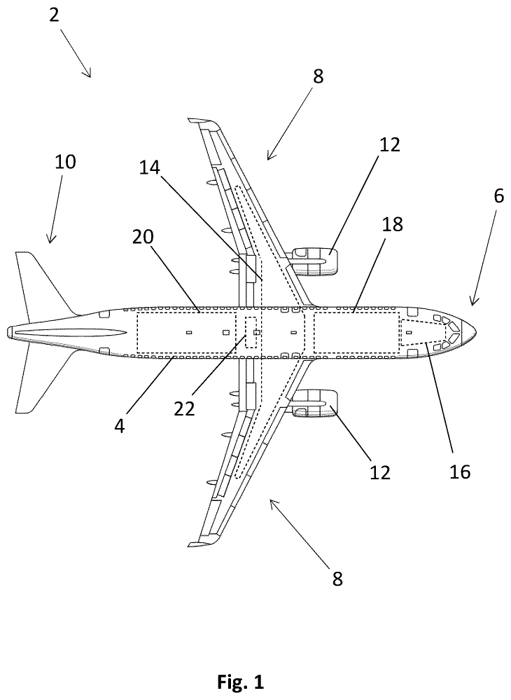

FIG. 1 shows an aircraft 2 according to a first embodiment of the invention. It has a fuselage 4 with a nose 6, two wings 8 and a tail 10. Each wing 8 extends from the fuselage 4 in a spanwise direction and supports an engine 12 part way along its spanwise length. An enclosure in the form of a fuel tank 14 extends inside the wings 8 and through the fuselage 4 therebetween. Behind the nose 6, roughly beneath the cockpit, is another enclosure 16 which, in this case, contains some of the power electronics of the aircraft 2. Also positioned within the fuselage is a cargo bay made up of a fore enclosure 18 and an aft enclosure 20. The aircraft 2 also has an enclosure inerting system 22 which is arranged to provide NEA to each of the enclosures 14, 16, 18, 20 as discussed below.

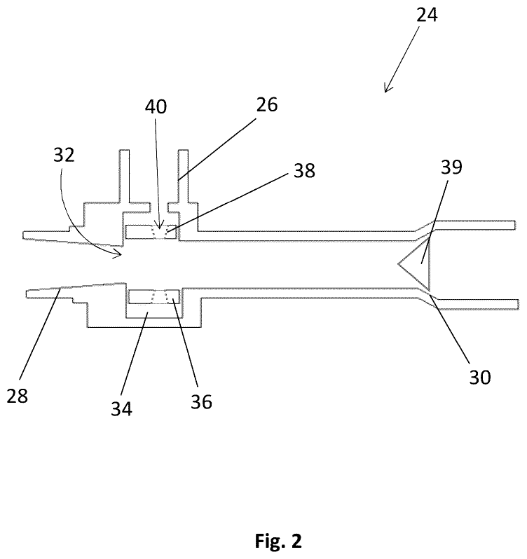

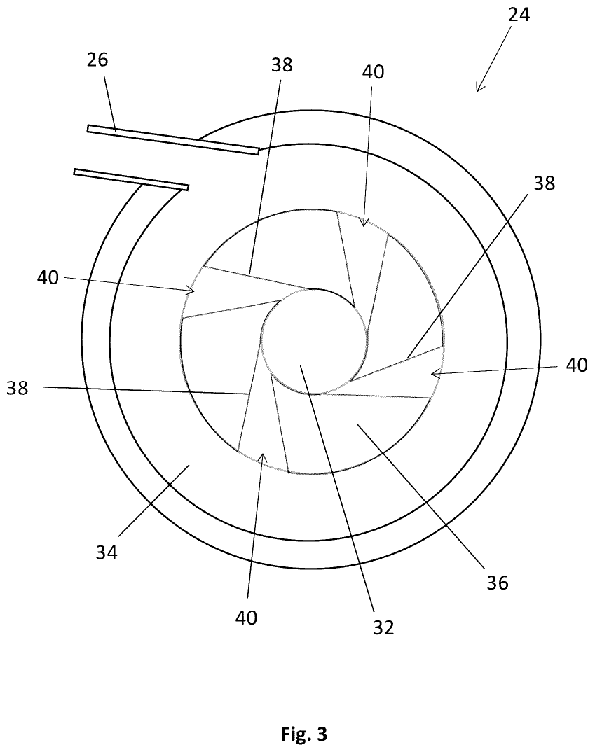

The inerting system 22 receives an inlet air flow from a ram air channel (not visible), then pressurizes it using a compressor (not visible) before cooling it using a heat exchanger (not visible) which brings the temperature of the compressed air down to a manageable level. The inerting system 22 separates the inlet air flow into NEA, which is supplied to the enclosures 14, 16, 18, 20 as needed, and OEA which is exhausted overboard. This separation of air takes place centrifugally, in a vortex tube of a vortex tube assembly. The vortex tube is shown schematically in FIGS. 2 and 3, which will now be referred to in combination with FIG. 1.

The vortex tube 24 has an inlet 26, an NEA outlet 28 and an OEA outlet 30. The vortex tube 24 defines a vortex chamber 32 which is circumferentially surrounded by an inlet chamber in the form of a plenum chamber 34. Positioned concentrically between the plenum chamber 34 and the vortex chamber 32, and separating the plenum chamber 34 from the vortex chamber 32 from each other, is a swirl generator 36. The swirl generator 36 has a set of four inlet passages 38 extending therethrough, positioned circumferentially around the vortex chamber 32 at intervals of 90 degrees. The inlet passages 38 provide respective flow paths 40 through which air can flow from the plenum chamber 34 into the vortex chamber 32. In this embodiment the inlet passages 38 take the form of tangential inlets which impart swirl into air flow entering the vortex chamber 32.

The NEA outlet 28 takes the form of a gradually widening aperture extending away from the vortex chamber 32 in one axial direction. The OEA outlet 30 takes the form of an annular passageway positioned circumferentially around a conical projection 39 and extending away from the vortex chamber 32 in the opposite axial direction to the NEA outlet.

In use of the vortex tube 24 in a normal mode, the inlet air flow enters the plenum chamber 34 through the inlet 26. The inlet air flow then enters the vortex chamber 32 tangentially through the inlet passages 38 of the swirl generator 36. The inlet passages 38 narrow towards the vortex chamber 32, which accelerates the air passing through them, and introduce the air into the vortex chamber 32 tangentially so as to impart swirl as mentioned above. As the air swirls within the vortex chamber 32, it separates into an outer vortex travelling helically in one direction (to the right from the perspective of FIG. 2) and an inner vortex travelling in the other direction (to the left from the perspective of FIG. 2), with both vortices rotating in the same direction.

The rotation of the air in the two vortices has the effect of throwing the heavier gasses outwards into the outer vortex, with lighter gasses remaining in (or being displaced into) the inner vortex. With oxygen being heavier than nitrogen, the oxygen tends to be thrown out into the outer vortex while the nitrogen tends to remain in the inner vortex. Accordingly, the inner vortex is made up of NEA and the outer vortex is made up of OEA. NEA in the inner vortex exits the vortex chamber 32 through the NEA outlet 28, whereupon in this embodiment it is fed to a storage tank (not shown) of the inerting system 22 for onward distribution to the enclosures 14, 16, 18, 20 as needed. OEA in the outer vortex exits the vortex chamber 32 through the OEA outlet 30, whereupon it is directed towards an exhaust port (not shown) of the inerting system 22 (and of the aircraft as a whole).

Heavier gasses being thrown out from the inner vortex and into the outer vortex also has the effect of expanding the air in the inner vortex and compressing the air in the outer vortex. This has the effect of cooling the NEA in the inner vortex and heating the OEA in the outer vortex.

In this particular embodiment, the position of the conical projection 39 is movable axially so as to vary the cross sectional area of the OEA outlet 30. Changing the cross sectional area of the OEA outlet 30 has the effect of altering the proportion of air which exits through that outlet 30 rather than the NEA outlet 28, which affects the relative sizes of the inner and outer vortices. This, in turn, affects the degree of air separation performed by the vortex tube 24 and the flow rates of OEA and NEA produced.

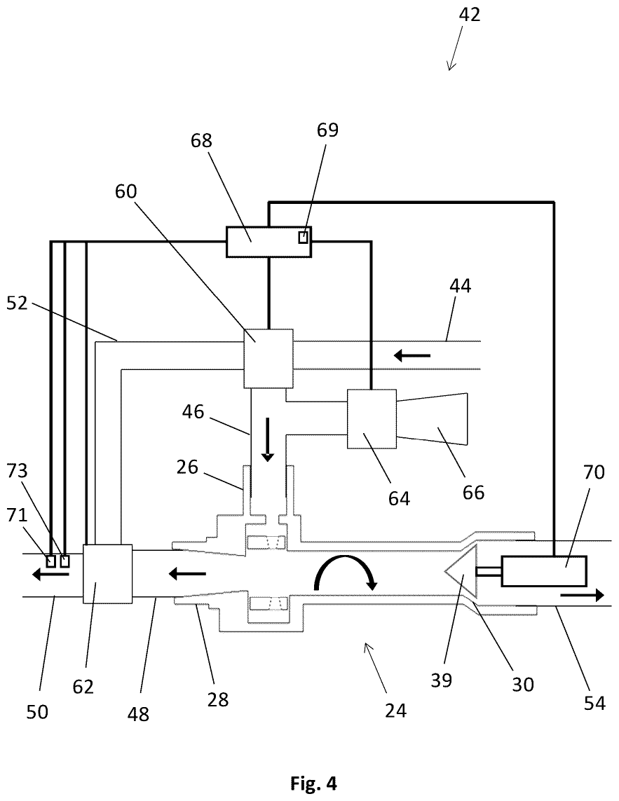

The vortex tube assembly 42 of the aircraft enclosure inerting system 22 is shown in FIG. 4, which will now be referred to in combination with FIGS. 1 to 3. As well as the vortex tube 24, the vortex tube assembly comprises a set of ducts, namely a feed duct 44, an inlet duct 46 connected to the inlet 26 of the vortex tube 24, an NEA duct 48 connected to the NEA outlet 28 of the vortex tube 24, a supply duct 50, a redirection duct 52, and an OEA duct 54 connected to the OEA outlet 30 of the vortex tube 24. The vortex tube assembly 42 also has a set of three valves. An inlet changeover valve 60 is operable to selectively connect the feed duct 44 to either the inlet duct 46 or the redirection duct 52. An NEA changeover valve 62 is operable to selectively connect the NEA duct 48 to either the redirection duct 52 or the supply duct 50. A waste valve 64 can be opened to connect the inlet duct 46 to a waste outlet 66, or closed to disconnect the inlet duct 46 and the waste outlet 66.

The vortex tube assembly 42 also has a controller 68 which is operably connected to each of the valves 60, 62, 64. The controller 68 is also operably coupled to an actuator 70, more particularly an electric linear actuator utilizing a lead screw mechanism, which is configured to move the conical projection 39 so as to widen or narrow the OEA outlet 30 as outlined above. The controller 68 has an in-built timer circuit 69, the purpose of which will be discussed later.

FIG. 4 shows the vortex tube assembly 42 in a normal mode, in which it separates an inlet air flow into NEA and OEA as outlined above. With the vortex tube assembly 42 in the normal mode the inlet changeover valve 60 is positioned to connect the feed duct to the inlet duct, the NEA changeover valve 62 is positioned to connect the NEA duct 48 to the supply duct 50, the waste valve 64 is closed (meaning that the inlet duct 46 is disconnected from the waste outlet 66) and the actuator 70 holds the conical projection 39 in a position in which the OEA outlet 30 is open but relatively narrow. The inlet air flow enters the vortex tube assembly 42 into the feed duct 44, passes into the inlet duct 46 through the inlet changeover valve 60, then passes into the plenum chamber 34 before passing into the vortex chamber 32 through the flow paths 40 defined by the inlet passages 38 in the swirl generator 36. As described above, inside the vortex chamber 32 the air is centrifugally separated into NEA and OEA. The NEA is exhausted from the vortex tube 24 through the NEA outlet 28 whereupon it passes through the NEA duct 48, through the NEA changeover valve 62, out of the vortex tube assembly 42 through the feed duct 50 and then on to one or more of the enclosures 14, 16, 18, 20. The OEA is exhausted from the vortex tube 24 through the OEA outlet 30, exits the vortex tube assembly 42 through the OEA duct and is exhausted from the aircraft 2.

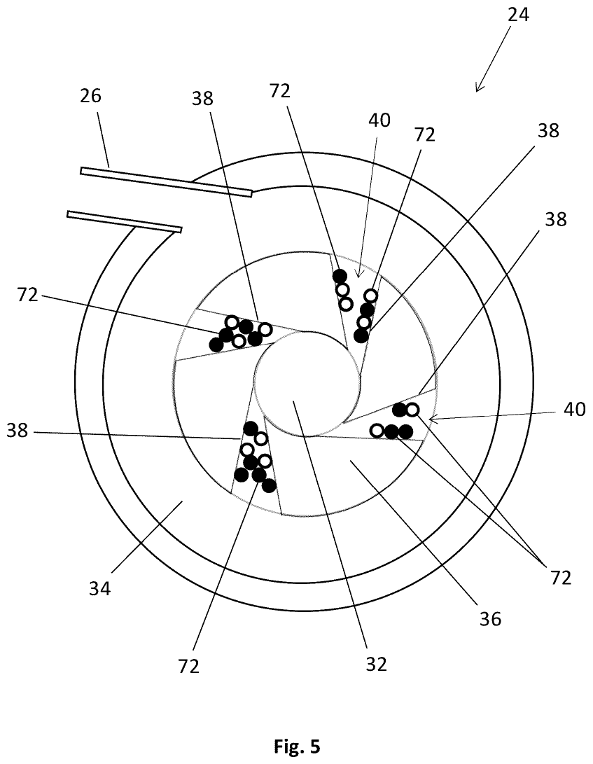

As discussed above, some vortex tubes are prone to clogging. FIG. 5 shows the vortex tube 24 of the present embodiment with the inlet passages 38 having been clogged by accumulated foreign matter 72 in the form of ice (white) and dirt such as oil, dust and smoke particles (black). From the perspective of FIG. 5 the two inlet passages 38 towards the left 38 have been completely blocked by the buildup of foreign matter 72, while the two inlet passages 38 towards the right are obstructed by the foreign matter 72 but the flow paths 40 are still partially open.

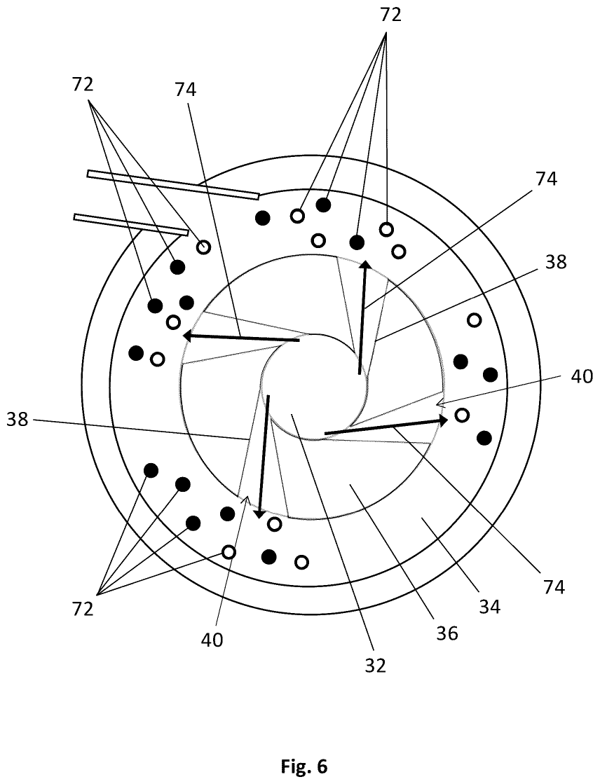

The accumulated foreign matter 72 can be cleared from the swirl generator 36 by operating the vortex tube 24 in a foreign matter clearance mode. In this mode, a reversed flow of gas is passed from the vortex chamber 32 to the plenum chamber 34 through the flow paths 40 provided by the inlet passages 38. This is illustrated in FIG. 6, with the reversed flow of gas 74 passing through each inlet passage 38 and forcing the foreign matter 72 back into the plenum chamber 34. This also acts to break up the accumulated foreign matter 72 into smaller fragments.

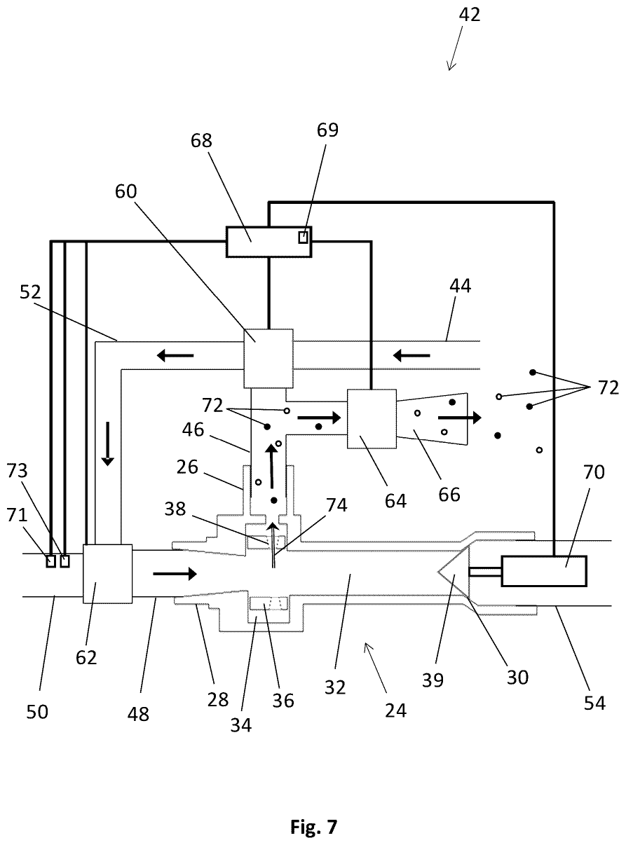

As shown in FIG. 7, to operate the vortex tube 24 in the foreign matter clearance mode the controller positions the inlet changeover valve 60 to connect the feed duct 44 to the redirection duct 52, positions the NEA changeover valve 62 to connect the NEA duct 48 to the redirection duct 52, opens the waste valve 64 to connect the inlet duct 46 to the waste outlet 66, and extends the actuator 70 so as to block the OEA outlet 30 with the conical projection 39 and prevent air flow therethrough. Accordingly, the inlet air flow passing through the feed duct 44 is diverted to the NEA outlet 28 through the inlet changeover valve 60, redirection duct 52, NEA changeover valve 62 and NEA duct 48. Thus, the inlet air flow is diverted from the inlet 26 to the NEA outlet 28, applying gas pressure (in this case air pressure) to the NEA outlet 28.

From the NEA outlet 28 the air then enters the vortex chamber 32, but since it enters axially minimal swirl is imparted and no separation of the air takes place. Since in this embodiment the OEA outlet 30 is closed, none of the air introduced into the vortex chamber 32 in the foreign matter clearance mode can escape through the OEA outlet 30. From the vortex chamber 32, the air passes (in the case of inlet passages 38 which are only partially blocked) or forces its way (in the case of inlet passages 38 which are completely blocked) into the plenum chamber 34 through the inlet passages 38 in the swirl generator 36, forming the reversed flow of gas 74. As it passes through the inlet passages 38, the reversed flow of gas 74 dislodges the accumulated foreign matter 72 as discussed above. The air, and dislodged foreign matter 72 entrained therein, then passes from the plenum chamber 34 into the inlet duct 46, through the waste valve 64, and is expelled through the waste outlet 66. The reversed flow of gas 74 continues to flow while the dislodged foreign matter 72 is being exhausted. In the present embodiment the foreign matter 72 is merely expelled into ambient conditions, but in some other embodiments it may be exhausted into an air filter or a waste sump and held there for disposal later.

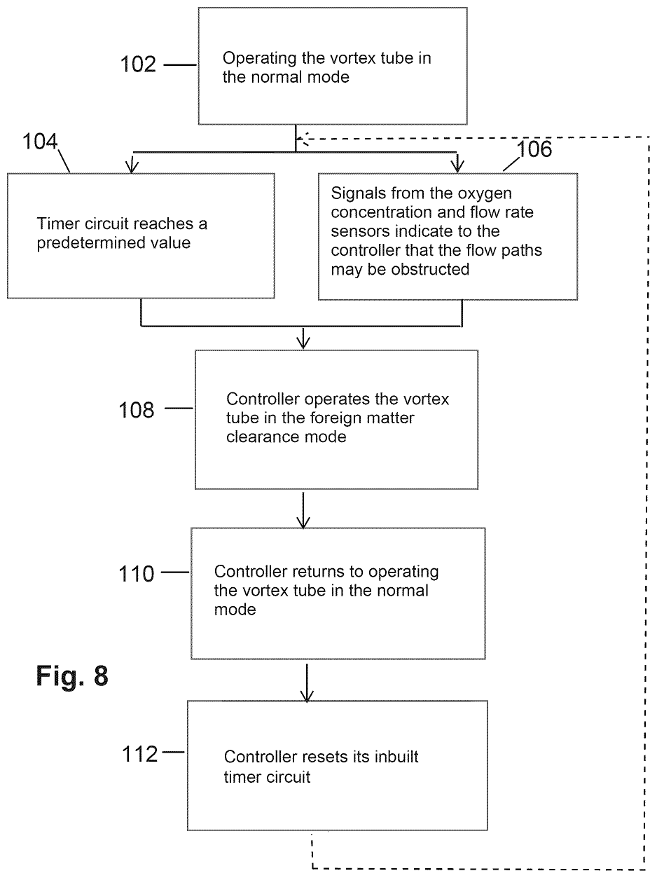

A method of using the vortex tube 24, and indeed of using the vortex tube assembly 42, will now be described with reference to FIG. 8 along with continued reference to FIGS. 1 to 7.

In a first step 102 the vortex tube 24 is operated in the normal mode. The controller 68 ensures that the valves 60, 62, 64 and the conical projection 39 are in the correct positions as outlined above, so that the vortex tube 24 receives the inlet air flow through the inlet 26, centrifugally separates it, exhausts NEA through the NEA outlet 28 and exhausts OEA through the OEA outlet 30.

Whenever the vortex tube 24 is operating, the timer circuit 69 of the controller 68 continues to run, and the controller monitors signals from oxygen concentration sensor 71 and a flow rate sensor 73 positioned in the supply duct 50 so as to detect if a possible obstruction occurs.

If either the timer circuit 69 of the controller 68 reaches 104 a predetermined value, or 106 the signals from the oxygen concentration and flow rate sensors 71, 73 indicate to the controller 68 that the flow paths 40 may be obstructed (for instance if the flow rate goes down and the oxygen level goes up), the controller 68 operates 108 the vortex tube 24 in the foreign matter clearance mode. It moves the valves 60, 62, 64 and the conical projection 39 to the positions discussed above, diverting the inlet air flow to supply gas pressure to the NEA outlet 28, thereby providing the reversed flow of gas 74. The reversed flow of gas 74 clears the accumulated foreign matter 72 (if present) and exhausts it through the waste outlet 66. In the present embodiment the controller moves all the valves 60, 62, 64 and the conical projection 39 at the same time, meaning that the OEA outlet 30 is widened at the same time as the reversed flow of gas 74 begins to flow.

After the controller 68 has operated the vortex tube 24 in the foreign matter clearance mode for a predetermined time deemed sufficient for all accumulated foreign matter 72 to be dislodged and expelled, in this case one minute, the controller 68 returns 110 to operating the vortex tube 24 in the normal mode by returning the valves 60, 62, 64 to their former positions and re-narrowing the OEA outlet 30 by returning the conical projection 39 to its original position. The inlet air flow is again centrifugally separated into OEA and NEA.

Once the controller 68 has returned the vortex tube 24 to the normal mode, it resets 112 its inbuilt timer circuit 69. Thus, the timer circuit 69 records the amount of time spent in normal mode since the last time the vortex tube 24 was operated in the foreign matter clearance mode. The vortex tube 24 can then continue to be used in the normal mode until, again, either the timer circuit 69 reaches the predetermined value or a potential blockage is detected.

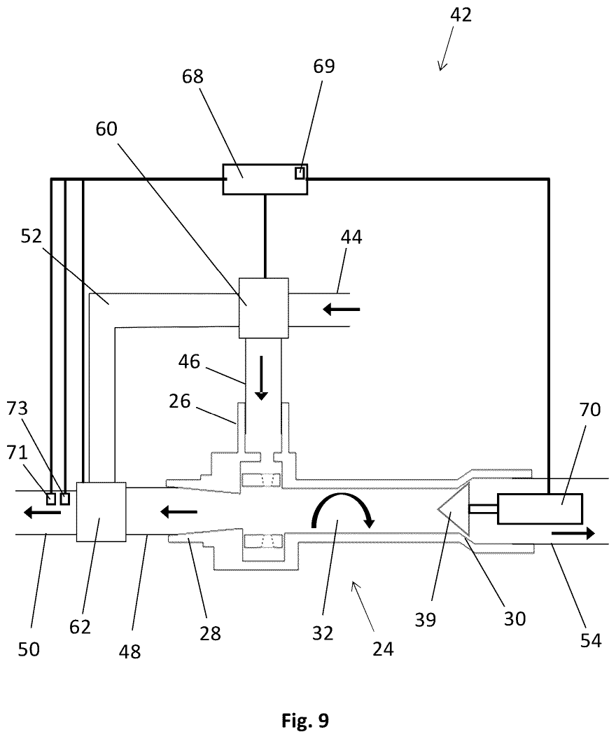

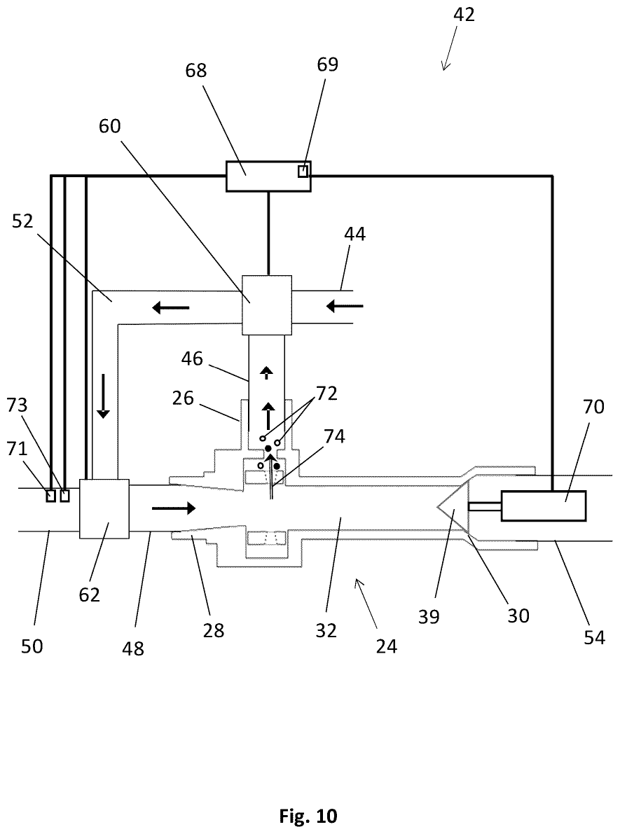

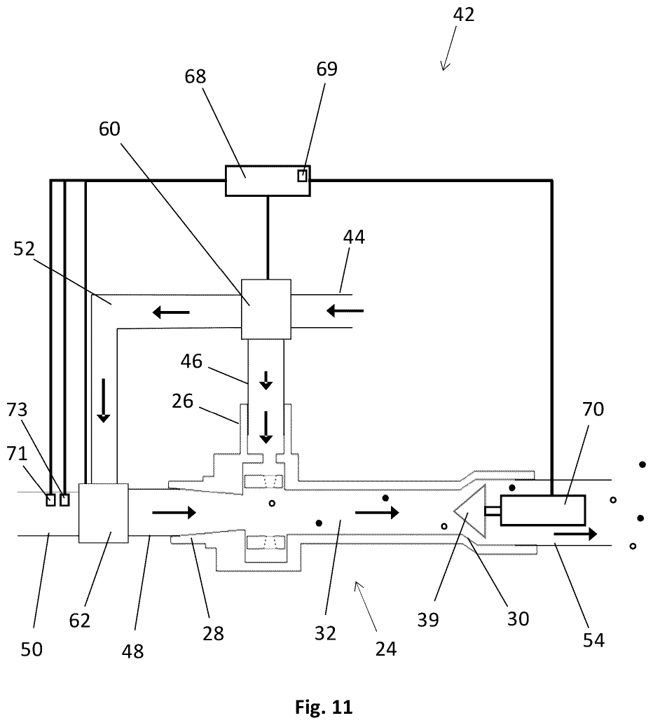

A second embodiment of the invention will now be described with reference to FIGS. 9 to 12 alongside FIGS. 1 to 8, with corresponding reference numbers denoting corresponding features. The second embodiment is similar to the first, therefore only the differences will be described here.

Structurally, the vortex tube assembly 42 of the second embodiment differs from that of the first embodiment only in that it does not have a waste valve or waste outlet. Instead, the inlet duct 46 extends solely between the inlet changeover valve 60 and the inlet 26 of the vortex tube 24. The vortex tube assembly 42 operates the same as that of the first embodiment when in the normal mode, with the inlet changeover valve 60, NEA changeover valve 62 and conical projection 39 in corresponding positions, as shown in FIG. 7.

Unlike the first embodiment, when the second embodiment is operated in the foreign matter clearance mode, as shown in FIG. 8, the reversed flow of gas 74 does not have a way of leaving the vortex tube assembly 42. Accordingly, when gas pressure is applied to the NEA outlet 28 the reversed flow of gas 74 lasts only a short time, until the air in the inlet duct 46 has been compressed and reaches the same pressure as the NEA outlet 28. In the present embodiment the volume of the inlet duct 46 allows the reversed flow of gas 74 to last long enough to dislodge accumulated foreign matter 72 and move it a short distance, but in other embodiments an expansion vessel may be connected to the inlet duct so that the reversed flow of gas 74 lasts longer before the pressure equalizes.

Whereas in the first embodiment, the dislodged foreign matter 72 is exhausted at the same time as the reversed flow of air 74 is provided, in the second embodiment it is exhausted after the reversed flow of gas has been provided, in a foreign matter flushing mode.

FIG. 9 shows the vortex tube assembly 42 with the vortex tube 24 operating in the foreign matter flushing mode. In this mode the positions of the valves 60, 62 are the same as when the vortex tube 24 is being operated in the foreign matter clearance mode, so gas pressure continues to be applied to the NEA outlet 28, but the conical projection 39 is moved further back so as to open the OEA outlet 30. Indeed, in this embodiment the OEA outlet 30 is wider when the vortex tube 24 is being operated in the foreign matter flushing mode than when it is being operated in the normal mode. In the foreign matter flushing mode, compressed air (with dislodged foreign matter 72) can flow back through the inlet passages 38 into the vortex chamber 32 and be exhausted through the OEA outlet 30, along with air flowing into the vortex chamber 32 from the NEA outlet 28.

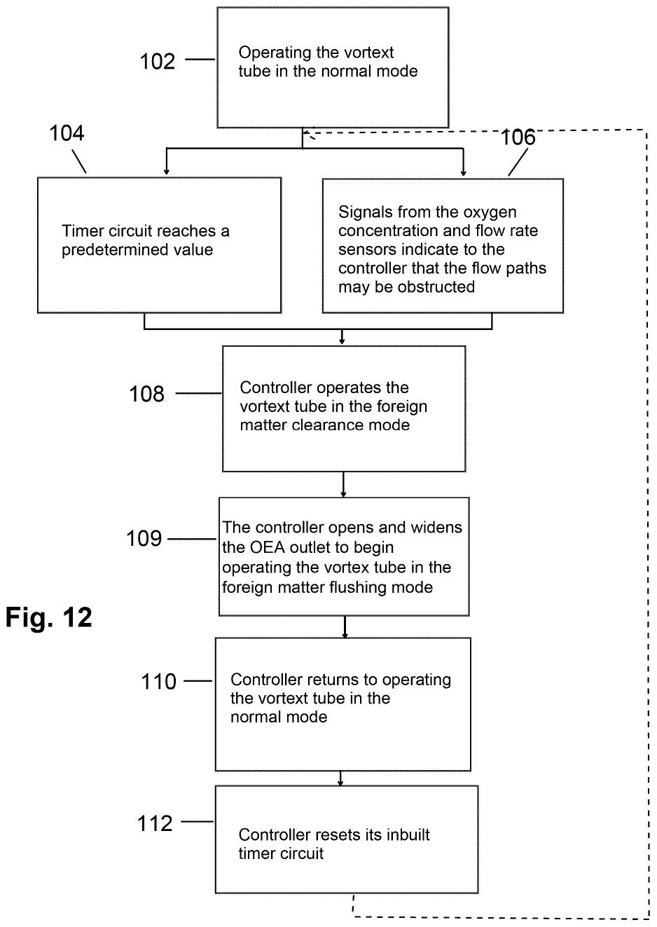

A method of using the vortex tube 24, and indeed of using the vortex tube assembly 42, of the second embodiment will now be described with reference to FIG. 12 along with continued reference to FIGS. 1 to 11. The majority of the steps of this method are the same as that of the first embodiment, therefore again only the differences will be described.

As with the first embodiment, when the controller 68 detects 106 a possible obstruction or its inbuilt timer circuit 69 reaches 104 the predetermined value, it operates the vortex tube 24 in the foreign matter clearance mode. After operating 108 the vortex tube 24 in the foreign matter clearance mode, the controller opens and widens the OEA outlet 30 so as to begin operating 109 the vortex tube 24 in the foreign matter flushing mode. After operation of the vortex tube 24 in the foreign matter flushing mode for a predetermined period, in this case 15 seconds, the controller 68 returns 110 to operating the vortex tube 24 in the normal mode and resets 112 its timer circuit 69.

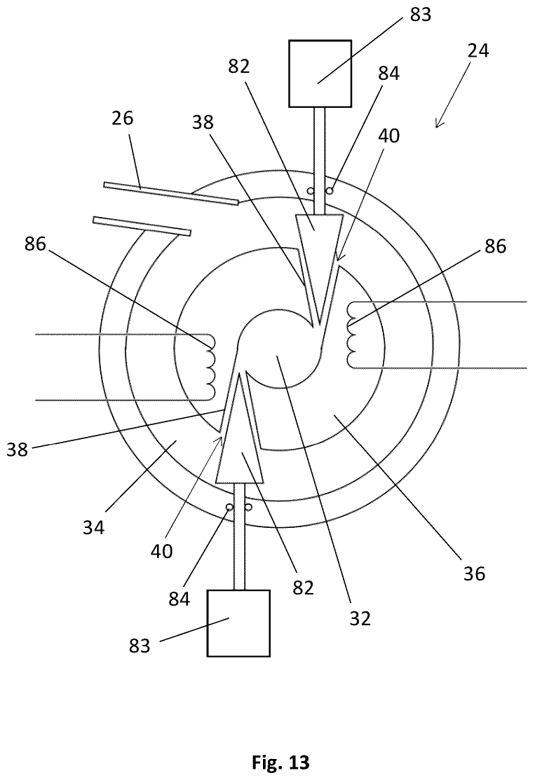

A third embodiment of the invention will now be described with reference to FIG. 13 alongside FIGS. 1 to 12, with corresponding reference numbers denoting corresponding features. The third embodiment is similar to the first embodiment, therefore only the differences will be described here.

Firstly, the swirl generator 36 of the vortex tube 24 of the third embodiment has two diametrically-opposed inlet passages 38, rather than four spaced apart from one another by 90 degrees. Further, each inlet passage 38 has a throttle pin 82 received therein. The throttle pins 82 extend through respective O-ring seals 84 which prevent leakage of air out of the plenum chamber 34. Whereas in the first and second embodiments the flow paths 40 are defined solely by the inlet passages 38, in the present embodiment each flow path 40 is co-operatively defined between the inner surface of one of the inlet passages 38 and the outer surface of the corresponding throttle pin 82. The flow paths 40 are therefore annular in cross sectional shape.

The throttle pins 82 are connected to respective actuators 83 which are operably coupled to the controller 68. The controller 68 can therefore move the throttle pins 82 relative to their respective inlet passages 38 so as to widen and narrow the flow paths 40. By moving the throttle pins 82 outward the flow paths 40 can be widened, and by moving the throttle pins 82 inward the flow paths 40 can be narrowed.

The vortex tube 24 of the third embodiment also differs from previous embodiments in that a pair of heating elements 86 are embedded in the swirl generator 36 so as to selectively apply heat thereto. The heating elements 86 are also operably connected to the controller 68, allowing the controller to turn them on and off and to control the amount of heating power delivered. In the present embodiment the controller 68 operates the heating elements 86 throughout operation of the vortex tube 24, regardless of the mode it is in, so as to combat the build-up of ice. When the vortex tube 24 is being operated in normal mode or the foreign matter flushing mode the controller 68 delivers relatively low power to the heating elements 86 so that they apply a low level of heat to the swirl generator 36, which is normally sufficient to prevent the buildup of ice but has a relatively modest effect on the power consumption of the vortex tube assembly 42. When the vortex tube 24 is being operated in the foreign matter clearance mode the controller 68 delivers more power to the heating elements 86 which in turn apply more heat to the swirl generator. The extra heating can be useful in melting ice on occasions where the inlet air flow is particularly cold (whereupon ice may still form when operating in the normal mode), and/or may melt or soften other types of foreign matter such as dirt so as to make it more easily dislodged.

In the present embodiment, the controller 68 moves the throttle pins 82 outward and back while the vortex tube 24 is operated in the foreign matter clearance mode. Thus, the flow paths 40 are widened and then re-narrowed during operation of the vortex tube 24 in the foreign matter clearance mode. The movement of the throttle pins 82 can help to dislodge accumulated foreign matter 72, and the widening if the flow paths 40 can make it easier to dislodge (for instance by increasing the flow rate through the flow paths 40, and/or by making a wider gap down which dislodged foreign matter can travel).

The controller 68 is also able to adjust the positions of the throttle pins 82 during operation of the vortex tube 24 in the normal mode so as to adjust the speed of air entering the vortex chamber 32, thereby adjusting the flow rate and/or purity of NEA produced.

The systems and devices described herein may include a controller, such as controller 68, control unit, control device, controlling means, system control, processor, computing unit or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

Moreover, throughout this document including the claims, expressions such as “at least one of”, or “one or more of”, when preceding a list of elements, modify the entire list of elements and do not modify the individual elements of the list.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents.

It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

The term ‘or’ shall be interpreted as ‘and/or’ unless the context requires otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Moreover, throughout this document including the claims, expressions such as “at least one of”, or “one or more of”, when preceding a list of elements, modify the entire list of elements and do not modify the individual elements of the list.

1. A method of clearing a swirl generator of a vortex tube for an aircraft enclosure inerting system, the vortex tube comprising:
an inlet chamber;
a vortex chamber which can receive air from the inlet chamber through at least one flow path in the swirl generator; and
a nitrogen enriched air (NEA) outlet and an oxygen enriched air (OEA) outlet,
wherein the method comprises:
operating the vortex tube in a normal mode by supplying an inlet air flow to the vortex chamber via the inlet chamber through the at least one flow path, centrifugally separating the inlet air flow into an NEA flow and an OEA flow in the vortex chamber, exhausting NEA from the vortex chamber through the NEA outlet and exhausting OEA through the OEA outlet; then
operating the vortex tube in a foreign matter clearance mode by providing a reversed flow of gas which passes from the vortex chamber to the inlet chamber through the at least one flow path and dislodges accumulated foreign matter from the at least one flow path; and
exhausting dislodged foreign matter from the vortex tube; then
operating the vortex tube in the normal mode again.

2. The method according to claim 1 wherein the reversed flow of gas is provided by applying gas pressure to at least one of the NEA and OEA outlets.

3. The method according to claim 2 wherein gas pressure is applied to said at least one of the outlets by diverting the inlet air flow to said at least one of the outlets.

4. The method according to claim 2 wherein the gas pressure is applied to at least the NEA outlet.

5. The method according to claim 1 wherein the exhaustion of dislodged foreign matter takes place while the reversed flow of gas is being provided.

6. The method according to claim 5 wherein the dislodged foreign matter is exhausted through a waste valve, the waste valve being open when the vortex tube is in the foreign matter clearance mode and closed whenever the vortex tube is in the normal mode.

7. The method according to claim 1 wherein the dislodged foreign matter is exhausted after the reversed flow of gas has been provided.

8. The method according to claim 7 wherein the dislodged foreign matter is exhausted through the OEA outlet.

9. The method according to claim 8 wherein the dislodged foreign matter is exhausted through the OEA outlet by placing the vortex tube in a foreign matter flushing mode in which gas pressure is applied to the NEA outlet.

10. The method according to claim 8 further comprising widening the OEA outlet before or during exhaustion of the dislodged foreign matter therethrough, then re-narrowing the OEA outlet before or during a subsequent operation of the vortex tube in the normal mode.

11. The method according to claim 1 wherein the vortex tube is operated in the foreign matter clearance mode upon detection of a possible obstruction of the at least one flow path.

12. The method according to claim 1 further comprising widening the at least one flow path before or during provision of the reversed flow of gas, then re-narrowing the at least one flow path before or during a subsequent operation of the vortex tube in the normal mode.

13. The method according to claim 12 wherein:
the, or each, flow path is co-operatively formed by an inner surface of an inlet passage extending through the swirl generator and an outer surface of a throttle pin received in said inlet passage; and
the, or each, flow path is widened and narrowed by moving the, or each, throttle pin relative to the corresponding inlet passage.

14. The method according to claim 1 further comprising applying heat to the swirl generator.

15. The method according to claim 14 wherein heat is applied to the swirl generator during operation of the vortex tube in the normal mode.

16. The method according to claim 15 wherein heat is applied to the swirl generator substantially throughout operation of the vortex tube in the normal mode.

17. The method according to claim 14 wherein heat is applied during operation of the vortex tube in the foreign matter clearance mode.

18. A vortex tube assembly comprising a vortex tube and one or more valves operably connected to a controller, the vortex tube comprising:
an inlet chamber configured to receive an inlet air flow;
a vortex chamber configured for centrifugal separation of the inlet air flow into a nitrogen enriched air (NEA) flow and an oxygen enriched air (OEA) flow;
a swirl generator having at least one flow path configured to allow the inlet air flow to enter the vortex chamber from the inlet chamber; and
an NEA outlet and an OEA outlet,
wherein the controller is configured to operate the one or more valves to move the vortex tube between:
a normal mode in which the inlet air flow passes from the inlet chamber through the at least one flow path into the vortex chamber and is centrifugally separated into the NEA flow and the OEA flow; and
a foreign matter clearance mode in which a reversed flow of gas is passed from the vortex chamber to the inlet chamber through the at least one flow path in the swirl generator so as to dislodge accumulated foreign matter from the at least one flow path.

19. The vortex tube according to claim 18 wherein the swirl generator is positioned concentrically between the inlet chamber and the vortex chamber.

20. An aircraft enclosure inerting system comprising a vortex tube according to claim 18.
